(19) United States
(12) Patent Application Publication
(10) Pub. No.: US 2017/0157865 A1
(43) Pub. Date: Jun. 8, 2017

(54) COMPOSITE FIBER MATERIALS

(71) Applicant: Hattar Tanin LLC, Novato, CA (US)

(72) Inventors: Saadeh HATTAR, Novato, CA (US); Volodymyr Tanin, Kiev (UA)

(21) Appl. No.: 15/371,080

(22) Filed: Dec. 6, 2016

Related U.S. Application Data
(60) Provisional application No. 62/263,843, filed on Dec. 7, 2015.

(51) Int. Cl. B29C 70/40; B29C 70/30

(52) U.S. Cl. CPC B29C 70/40; B29C 70/30; B29L 2031/3076

(57) ABSTRACT

The disclosure provides a method for preparing a composite article of manufacture by obtaining a first fabric made from a composite thread of a first fiber material having a first melting temperature and a second fiber material having a second melting temperature. The fabric is layered in a mold for the composite article of manufacture, pressing while in the mold, and heated while in the mold. Heating is performed at a third temperature that is close to, at or above the first melting temperature of the first fiber material and below the second temperature of the second fiber material.

### CROSS REFERENCE TO RELATED APPLICATION

This application claims priority to United States Provisional Patent Application No. 62/263,843, entitled “Innovative Composite Fiber Materials Technology,” filed Dec. 7, 2015, which is hereby incorporated by reference.

### TECHNICAL FIELD

This specification describes composite fiber materials and methods for preparing the composite fiber materials.

### BACKGROUND

Composite fiber materials are becoming wide-spread and are used in a wide array of applications, from cookware to aeronautics. However, the manufacturing process for materials made with composite fibers can be slow and tedious. Improved methods that enable quick manufacturing of materials of any size and shape and with high uniformity from composite fibers are needed.

### SUMMARY

The present disclosure solves these and other problems by providing improved composite fibers and manufacturing methods for using these improved composite fibers. The improved composite fibers described herein are formed from at least two types of fibrous material having different melting temperature, a first type of fiber that imparts strength into the composite material and a second type of fiber that binds the composite material together. By heating the composite material work-piece at a temperature, which is usually above the melting point of the second fibrous material (but may be the same, or lower from melting point of the second fibrous material, when second fibrous material gets softened), but below the melting point of the first fibrous material, the second fibrous material melts (as a rule, forming a single matrix) and then, after cooling, binds the whole structure together.

This method overcomes limitations associated with the use of liquid adhesive agents in conventional composite material manufacturing. For example, conventional composite-fiber goods and materials are produced using liquid bonding resins. This process requires extensive labor, e.g., to form multiple layers of material to achieve a desired thickness and/or strength and to roll-out air cavities formed within the composite material. In-fact, it is not possible to form thick composite-fiber articles with high structural uniformity using liquid resins. Also, these liquid resins form solid polymer blocks when they dry. These polymer blocks are significantly more fragile than linear polymers.

Further, conventional technologies for composite manufacturing, which require liquid bonding resins exclude the use of solid polymers, like polyvinylchloride, polyethylene, nylon, etc., a binding agents. This is especially true when the manufactured article has considerable thickness. Moreover, it is not possible to impregnate conventional structural fibers with low melting temperatures when using high-temperature binding agents, such as liquid glass or aluminum, especially when the article of manufacture is relatively thick (e.g., at least 50 cm thick).

Described herein are composite fiber materials made from several types of fiber, some of which are armoring fibers (e.g., fibers that impart strength into a material) and some of them are binding-agent-fibers (e.g., fibers that bind the composite material together). Armoring and binding-agent-fibers are used to make threads, threads are used to make textile or fabric (or non-woven material layers from multiple threads, hereinafter encompassed within fabrics) and multiple layers of fabric are used to make any-thickness-details by vacuuming, pressing/forming and heating to melt the binding agent fibers.

Also described are improved manufacturing methods for preparing composite materials from these composite fibers. The methods described herein enable quick manufacturing (e.g., ranging from several seconds to several minutes, depending on thickness) of these composite materials. The methods also enable manufacturing of composite materials having any thickness, e.g., from 0.05 cm, or less) to 50 cm, or more (e.g., 5 cm, 10, cm, 20 cm, 30 cm, 40 cm, 50 cm, etc). The methods described herein also enable production of composite goods with high uniformity.

In some embodiments, the composite materials are composites of a fibrous material and a plastic.

In some embodiments, the methods provided herein enable impregnating the composite material with, e.g., ceramic, metal, or another material, for example as a plate or other structure.

The methods described herein allow for quick manufacture of, e.g., bullet-proof vests, bodies of armored and civil vehicles, planes, helicopters, and vessels, with sizes ranging up to at least 25 meters, as a single piece of material.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 illustrates an exemplary method for manufacturing the composite materials described herein, according to some implementations.

### DETAILED DESCRIPTION

Reference will now be made in detail to implementations of the present application as illustrated in the accompanying drawings. The same reference indicators will be used throughout the drawings and the following detailed description to refer to the same or like parts. Those of ordinary skill in the art will realize that the following detailed description of the present application is illustrative only and is not intended to be in any way limiting. Other embodiments of the present application will readily suggest themselves to such skilled persons having benefit of this disclosure.

In the interest of clarity, not all of the routine features of the implementations described herein are shown and described. It will, of course, be appreciated that in the development of any such actual implementation, numerous implementation-specific decisions must be made in order to achieve the developer's specific goals, e.g., composite materials with desired characteristics (e.g., strength, flexibility, durability, etc.) for different type of products. Moreover, it will be appreciated that such a development effort might be complex and time-consuming, but would nevertheless be a routine undertaking of engineering for those of ordinary skill in the art having the benefit of this disclosure.

This disclosure relates to methods for producing composite materials, by combining armoring fibers and binding-agent fibers into threads, which provides uniform distribution of binding agents within the composite material. Forming composite materials from these composite threads, and/or from fabric (e.g., a textile) produced using this composite thread, provides this uniform distribution.

Described herein are composite fiber materials made from several types of fiber, some of which are armoring fibers (e.g., fibers that impart strength into the composite material) and some of them are binding agent fibers (e.g., fibers that bind the composite material together). Armoring and binding fibers are used to make threads, threads are used to make fabric and multiple layers of fabric are used to make a composite material with a desired thickness by vacuuming, pressing/forming and heating for some melting of binding agent fiber(s). Also described are methods for manufacturing these composite materials.

As referred to herein, “armoring fibers” are fibers that impart strength into a composite material. These fibers have melting temperatures that are greater than the melting temperature of corresponding binding agent fibers. As such, a treatment temperature is selected at which the binding agent fiber, but not the armoring fiber, melts and/or is softened to a point at which it may form a matrix within the composite material. This treatment temperature is used during manufacturing for thermal integration (e.g., binding) of composite material formed by a composite fiber and/or a composite fabric formed with the composite thread. Armoring fibers, as such, do not lose their fiber structure during and after the process of thermal integration/joining during manufacturing of the composite material. E.g., each armoring fiber remains as a fiber with same or similar parameters of thickness and length during manufacture. Armoring fibers are not melted during the process of thermal integration/joining, e.g., two armoring fibers are not joined together with material, from which they are made from (for example, when armoring fibers are made from steel of certain grade—they are not joined together with steel of above grade/for example, when armoring fibers are made from certain sort of glass—they are not joined together with glass of above sort).

Non-limiting examples of armoring fibers include carbon fibers, glass fibers, mineral fibers (e.g., melted rock, aluminum oxide, etc.), aramid fibers, nylon fibers, other organic fibers (e.g., with high tensile strength and comparatively high melting temperatures relative to a selected binding agent fiber), metal fibers, and metal alloy fibers.

As referred to herein, “binding-agent fibers” are fibers that bind the composite material together. These fibers have melting temperatures that are lower that than the melting temperature of corresponding armoring fibers. As such, a treatment temperature is selected at which the binding agent fiber, but not the armoring fiber, melts (e.g., a binding temperature of at or above the melting point of the binding-agent fiber is selected). This treatment temperature is used during manufacturing for thermal integration (e.g., binding) of composite material formed by a composite fiber and/or a composite fabric formed with the composite thread. These fibers lose their fibrous structure during and/or after the process of thermal integration (e.g., binding) of the composite material. Binding-agent fibers are melted during the process of thermal integration/joining, e.g., the binding-agent fibers of a composite material join together with material, from which they are made from (material, which is generated in process of melting of such fibers), to create matrix that binds the armoring fibers together.

For example, binding agent fibers made from aluminum of a certain first grade are joined together with aluminum of a higher second grade, to form a single aluminum matrix upon melting and then cooling back into a solid state. E.g., when binding-agent-fibers are made from aluminum of X-grade, after processing these X-grade aluminum binding-agent-fibers are converted into single matrix from X-grade aluminum.

Similarly, when binding agent fibers are made from certain Y-sort of glass—they are joined together with glass of above Y-sort to form a single matrix from Y-sort of glass upon melting and then cooling back above Y-sort of glass into a solid state. E.g., when binding-agent-fibers are made from Y-sort glass, after processing these Y-sort glass binding-agent-fibers are converted into single matrix from Y-sort glass.

Non-limiting examples of binding-agent fibers include organic polymer fibers (e.g., nylon, kapron, polyethylene, polyprpylene, polyvinylchloride, etc.), thermo-reactive polymer fibers (e.g., various rubbers), glass fibers, mineral fibers, metal fibers, metal alloy fibers, each of which has a lower melting temperature relative to a corresponding armoring fiber.

In one embodiment, where aluminum fibers are used as a binding agent fiber, the thermal integration process is carried out at a temperature between about 450° C. and 500° C., although alluminum has a melting temperature of about 700° C. This is possible, because when pressure is applied to aluminum (e.g., by pressing or rolling) at temperatures at or above 450° C., but below the melting temperature, aluminum fibers are annealed/integrated into a single matrix. That is why, in some embodiments, an integration temperature below the melting temperature of corresponding binding-agent fiber can be used in the manufacturing processes described herein.

In some embodiments, a same type of glass fiber with a comparatively low melting temperature is used both as binding-agent fiber and as an armoring fiber, due to its amorphous properties. E.g., at temperatures near the melting temperature of the glass, the fibers will melt on their surface, but remain solid within their core. This may be used, for example, to produce disposable table-ware, such as from glass cotton, which can be recycled multiple times.

The process of thermal integration (e.g., melting the binding agent fiber to form a supportive matrix), hereinafter referred to as “thermal integration”, can be carried out, for example, by (a) vacuuming, pressing, heating & forming with further cooling of the work-piece together with pressing form or, in some cases as (b) rolling with pressure and heating of the roll (e.g., as used, for example, to unite three layers of metal {stainless steel-aluminum-stainless steel}, into three-layer laminated thin slabs used for professional kitchenware, e.g., frying pans and stewing pans. As appreciated by the skilled artisan, the process of thermal integration can be modified to suit a particular purpose, but the heating and compression of the material being formed will always occur.

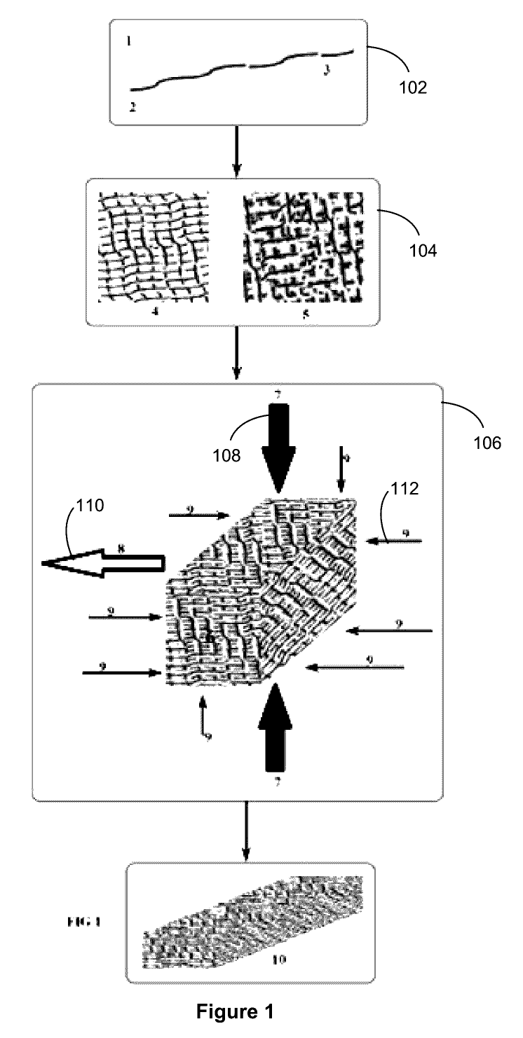

Referring to FIG. 1, a method is provided for preparing a composite article of manufacture 10. The method includes obtaining (104) a first fabric 4 or 5 made from a composite thread 3, the composite thread comprising a first fiber material 1 (e.g., a binding-agent fiber) having a first melting temperature and a second fiber material 2 (e.g., an armoring fiber) having a second melting temperature. The fabric is layered (106) in a mold 6 for the composite article of manufacture. The fabric is then pressed (108) while layered, being located in the mold 6. In some embodiments, the mold 6 is hermetically sealed and gas is removed (110) from the mold. The fabric is then heated (112) in the mold at a third temperature (e.g., to anneal/integrate the composite fabric in the mold), where the third temperature is at or above the first melting temperature of the first fiber material 1 and below the second temperature of the second fiber material 2.

In some embodiments, the methods described herein are adapted for: 1) Technology for production of armoring-fiber(s)/[plastic/resin/rubber] composite(s)/[composite good(s)] (as armoring fiber it is possible to take glass fibers, aluminum oxide fibers, aramid fibers, carbon fibers and/or any other fibers); 2) technology for production of armoring plastic/[plastic/resin/rubber] composites; 3) technology for production of armoring glass fiber(s)/glass composite(s)/[composite good(s)]; 4) technology for production of armoring fiber/metal fiber composites; 5) technology for production of metal fiber/metal fiber composites; 6) technologies for production of other fiber based and/or fiber composite materials.

In some embodiments, the methods described herein allow technologies of high speed manufacture of gas bombs/bulbs, tanks, bodies and other details of planes/helicopters and of the other manufactures with cavities/pockets, which can be produced in the single piece totally or nearly without seams.

In some embodiments, the methods described herein allow technologies of metal fiber/[metal fiber/metal powder metallurgy].

In some embodiments, the methods described herein allow technologies of metal fiber/liquid metal technologies.

In some embodiments, the methods described herein allow structured self-composites, when even all fibers are made just from the one type of material and/or from several types of material with the similar and/or near temperature of melting.

Starting to describe abovementioned composites, we are starting from “High-speed (from several seconds to several minutes, depending on thickness) industrial technologies for fiber-plastic goods manufacture” and one of the key-principles on how to make it.

This key-principle consists in the fact, that we do not rely on any liquid binding agent to make fiber-based composite, but we use two or more types of material for fibers, and fibers on the base of one or more types of material are used as armoring fibers, and fibers on the base of one or more types of material (and this/these type(s) of material(s) as it is/as they are) are used as binding agent (hereinafter named as binding agent fibers). Binding agent fibers can also partly play role of armoring fibers.

By uniting/merging armoring fiber(s) and binding agent fiber(s) we receive united composite fiber(s)/thread(s) (hereinafter named as united composite fiber(s) or as united composite thread(s)). Fibers of different types are tightly twisted into strings/threads. For example a thread may be made of glass fiber as armoring fiber and polyethylene fiber as binding agent fiber.

It is possible to regulate properties of united composite fiber(s) (and also properties and characteristics of the final goods on the base of united composite fiber(s)) by changing percentage/quantity of armoring fiber(s) and binding agent fiber(s) in the united composite fiber(s)/threads, using any/specified processing of the received united composite fiber(s) before use/implementation for making of final goods/manufactures and/or by changing properties and/or content of armoring fiber(s) and binding agent fiber(s), which make united composite fiber(s).

To make final manufacture(s)/good(s), using united composite fiber(s), we can use united composite fiber(s) in the form of multiple united composite fiber(s) [hereinafter named/can be named as united composite fiber(s) material(s)] and/or we can make (and then use) nonwoven material(s) on the base of/using/from united composite fiber(s) [hereinafter named/can be named as united composite fiber(s) material(s)], and/or we can make (and then use) fabric(s)/textile(s) on the base of/using/from united composite fiber(s) [hereinafter named/can be named as united composite fiber(s) material(s)].

To unite together united composite fiber(s) material(s) into final manufacture(s)/good(s) we offer several methods.

For the first method the first action starts with preparation of workpiece using united composite fiber(s) material(s), matching it under the necessary parameters (length, width, thickness, support of specified zones with extra of united composite fiber(s) material(s) . . . ). Prepared workpiece have to be placed into the special press form, where space between the parts of press form, when it is closed, makes (or nearly makes) the form of the desired manufacture.

The next steps are (1) pumping off (vacuuming/degasifying) all the air (or anything else) from the form and i.e. from the united composite fiber(s) material(s) workpiece, (2) pressing/forming this workpiece in the form and (3) heating it to melt binding agent fiber(s). This all three steps can be carried out simultaneously or in any necessary order.

United composite fiber(s) material(s) workpiece can be made in such a way, that it is ready to be vacuumed, pressed/formed and heated or in process of pressing it must get the necessary form, being stretched (united composite fiber(s) material(s) can be provided with possibility to be stretched in all the directions uniformly, with specified/necessary unit-stretching for every specified direction or with property/possibility to be stretched in one direction and not to be stretched in the other one [such properties, for example, are provided for nylon reinforcing fabric for some tires, which is able to be stretched in width, but can't be stretched in length]).

When using united composite fiber(s) material(s) (especially that, which can/are finally formed by press form), it is possible to speed up manufacturing process in multiple times, with minimum time, forces and actions to prepare united composite fiber(s) material(s) workpiece, with minimum time to carry out all the manufacturing process, including vacuuming, pressing and heating, from several seconds to several minutes (depending on types of engaged materials, maximum thickness of manufacture and, possibly, depending on other factors and technological specifics) and with possibility to make the process absolutely automatic.

Simplified process of making thick details of composite fiber is depicted at FIG. 1. Armoring fiber 1 and binding agent fiber 2 are tightly twisted to produce a thread 3. Threads 3 are used to produce fabric 4 or nonwoven material 5. Multiple layers of fabric 4 or 5 marked as 6 are pressed 7, vacuumed 8 and heated for some melting of binding agent fibers 9 to produce a thick bar (detail) 10.

a) Such technology provides possibility to exclude structural defects due to air cavities inside the structure of manufactures fiber-composite goods.

b) Such technology provides possibility to manufacture fiber-composite goods with extra structurally organized mechanical parameters and with possibility to reinforce the goods by reinforcing fibers not only in frames of layer/surface, but reinforcing goods with reinforcing fibers for the whole volume/thickness [from surface to surface], as there is possibly to thread united composite fiber(s) material(s) workpiece or using nonwoven material(s), where fiber(s) from the upper layer(s) can penetrate and to be bonded with fiber(s) from the down layer(s).

c) Such technology provides possibility to use as binding agent not only liquid resins, but also solid/amorphous/non-liquid polymers, resins and/or rubbers, including polymer materials, which undergo 3D polymerization (polymerization between molecules) at some conditions (like heating, illumination . . . ). This opens absolutely novel variants of fiber-composite materials, as before it was necessary to use just liquid resins, which are able to soak/permeate between armoring fibers, and now our technology allows to use nearly all non-3D-polymers (including that, which can be 3D-polymerised in process of form-fixing during manufacture).

d) Such technology provides possibility to produce fiber-composite manufactures with nearly unlimited thickness, during the shortest period of time, generally from tens of seconds up to several minutes saving the highest uniformity as there is no air inside and all the armoring fibers are already “soaked” with binding agent.

e) Such technology provides possibility to impregnate ceramic, metal and/or any other material(s) plate(s) (and/or other form objects) into fiber composite manufactures saving high speed of manufacture and high uniformity and possibility to produce goods with nearly any thickness.

f) And we underline that such technology provides possibility to manufacture high quality fiber composites with the highest speed from several seconds to several minutes.

Using united composite fiber(s) material(s) there is also possibility to carry out process by rolling and heating. In such process vacuuming can be used or not. Such processing is better to be used for flat-form goods (but for other-form goods it can be used too). In some cases such processing can lower structural uniformity.

Abovementioned technology(ies) can be adopted/matched for high-speed manufacture of bullet-proof vest, bodies of armored and civil vehicles, trucks, helicopters, planes (for example such part as longeron/(wing) spar, the body of the plane), construction details for skyscrapers and for other buildings, and vessel bodies, decks and other details/parts up to 25-40 m and possibly more in a single piece and other goods.

In some embodiments, the methods and composites described herein allow:

1) Technology for production of armoring-fiber(s)/[plastic/resin/rubber] composite(s)/[composite good(s)] (as armoring fiber it is possible to take glass fibers, aluminum oxide fibers, aramid fibers, carbon fibers, metal fibers and/or any other fibers). This is a classical variation of the technology, which has multiple benefits including that mentioned above from “a” to “f”.

2) Technology for production of armoring plastic/[plastic/resin/rubber] composites. Using one or more polymer fibers type(s), as armoring fibers, and one or more polymer fibers type(s), as binding agent fibers, saving multiple benefits including that mentioned above from “a” to “f”.

3) Technology for production of armoring glass fiber(s)/glass composite(s)/[composite good(s)]. It is very interesting application of our innovations, for which as armoring fibers we use glass fibers with high temperature of melting and as binding agent fibers—glass fibers with low temperature of melting. Using such composite materials, which are highly durable, it is possible to produce furniture details and furniture units, like tables, chairs . . . either for indoor and for outdoor use, kitchen furniture, kitchen and bathroom surfaces, flooring, tiles/thin slabs and dalle, sidings, tanks and pipes for food industry and many other applications.

4) Technology for production of armoring fiber/metal fiber composites. In this variation metal fibers are used as binding agent fibers, for example making united composite fiber(s) material(s), especially fabrics from aluminum fibers (binding agent fibers) and ceramic/glass fibers [better to take glass with much higher melting temperature from aluminum]. To make from such united composite fiber(s) material(s) single peace, we can use vacuuming/pressing/heating formation and/or rolling and heating [with or without vacuuming], and/or any other processing(s). Such manufactures will be especially interesting for armored vehicles of any type from armored cars up to armored, panzer vehicles, from civil aviation planes and helicopters manufacturers, or to military ones.

5) Technology for production of metal fiber/metal fiber composites. For this variation we can provide example of united composite fiber(s) material(s) [this case fabrics] from aluminum alloy fibers (binding agent fibers) and steel fibers (armoring fibers). As armoring fibers we can use ceramic and/or glass fibers, carbon fibers and/or any other type fibers. To process such united composite fiber(s) material(s) into single peace it will be better to use heating and rolling, but other variant of processing also can be used.

6) Technologies for production of other fiber based and/or fiber composite materials. One of the possible implementations is making fibers, especially natural fibers like cotton, more durable, strong and attrition/abrasion resistant, saving “breathing” for fabrics, which are made from such fibers. For example we can use cotton fibers and any polymer(s) fiber to make thread. After heating and pressing of such thread we can make from it fabrics/textiles, which are more durable, strong and attrition/abrasion resistant and in the same time, clothes from such material(s) will be able to save its comfort and other characteristic.

These abovementioned technologies can be modified for any other purposes too.

Here are some specific uses to produce highly demanded products.

I) Technologies of high speed manufacture of gas bombs/bulbs, tanks, bodies and other details of planes/helicopters/[of other vehicles] and of the other manufactures/goods with cavities/pockets, which can be produced in the single piece totally or nearly without seams.

As initial internal-form-base for some type of objects it is good to use some sort of material(s) or materials combination, which can save form during pressing and heating, but can be easily evacuated. For such purpose we can use, for example, sodium chloride (NaCl)/[sodium chloride, which is mixed with some fiber and/or combined with some fiber materials to keep the form], i.e. salt, which can be easily washed off/dissolved by water, or aluminum form base, which can be dissolved by acid (when such variant of internal base form evacuation will not spoil final manufactures/goods). Other variants of internal-form-base materials/structures also can be used. If the object is big enough and it is appropriate, it is possible to use simple steel dismountable internal-form-base (for example for railcar/wagon or truck tank(s)).

After covering of the internal-form-base with necessary united composite fiber(s) material(s), possibly threading in the necessary places and in necessary way united composite fiber(s) material(s) during process of internal-form-base covering and/or making any other necessary actions, it is necessary to locate covered internal-form-base into the necessary press form. By vacuuming, pressing, heating and forming it is possible to produce necessary manufacture(s). After evacuation of internal-form-base we get final goods. As the final goods we can get fiber-composite gas bombs/bulbs, tanks, bodies and other details of planes/helicopters/[of other vehicles], like car frames without seams. Any other goods can be also manufactured, using such technology.

II) Technologies of metal fiber/[metal fiber/metal powder metallurgy], where it is used small pieces of armoring fibers, binding agents fibers and/or (optionally) powder made from the same material as binding agent fibers.

Understanding, that we've created technology of “dry” fiber-composites manufacture, we think, that it is good to implement modified interpretation of it for powder metallurgy industry. To make any manufacture we can use not only metal powder, but multiple metal fibers or multiple metal fibers together with metal powder. From our point of view the best mode in this case will be multiple metal fibers together with metal powder, as metal powder can fill all free zones and multiple metal fibers can provide extra structural integrity, saving common/standard technological process(es), which is/are used in powder metallurgy industry. Parameters of fibers and their content must be adjusted for exact technology and demands.

III) Technologies of metal fiber/liquid metal technologies.

For example, using liquid aluminum alloy we can reinforce it with steel fibers [and/or iron/aluminum alloy fibers] before casting into the necessary form. Steel (and/or other metal(s)) fibers can be added to the melted liquid aluminum and/or to the casting form. Any other combinations of metal(s) and metal fibers are also possible.

IV) Structured self-composites, when even all fibers are made just from the one type of material and/or from several types of material with the similar and/or near temperature of melting.

Using just one type of material to make fibers for united composite fiber(s) material(s) (the same fibers play role of binding agent fibers and role of reinforcing fibers) provides unique possibilities and unique properties for final manufactures/goods.

For example, using multiple layers steel and/or aluminum fibers fabric by heating and rolling we can receive single piece manufacture, which is made just form the metal(s), but it is specifically structured. After processing, fibers are bonded together, but they saved much of their fiber structure and fiber properties.

Using just glass fibers and/or glass wool/glass cotton from glass with melting temperature of, for example, 350-650° C. (glass with any other temperature of melting also can be used) by heating and pressing/forming we can produce disposable tableware (like plates, cups, knifes, spoons, forks . . . ), various packings and many other goods. And such used disposable tableware can be reprocessed/recycled multiple times/endlessly for 100% into the same disposable tableware . . . .

Everyday tableware, furniture, building materials and many other goods can be produced too.

(Multiple glass fibers can be bonded by heating and pressing at lower temperature, when they are processed with NaOH and/or with liquid glass.)

Multiple layers of polymer fiber fabrics also can be bonded together by vacuuming, pressing, heating and forming, but for saving uniformity and fiber structure properties it is better to carry out heating very slowly.

### Exemplary Embodiments

In one aspect, the present disclosure provides a method for preparing a composite article of manufacture, including: obtaining a first fabric made from a composite thread, the composite thread comprising a first fiber material (e.g., a binding-agent fiber) having a first melting temperature and a second fiber material (e.g., an armoring fiber) having a second melting temperature, layering the first fabric in a mold for the composite article of manufacture, pressing the first fabric layered in the mold, and heating the first fabric layered and pressed in the mold at a third temperature (e.g., to anneal/integrate the composite fabric in the mold), wherein the third temperature is close to, at, or above the first melting temperature of the first fiber material and below the second temperature of the second fiber material.

In some embodiments, the method also includes, prior to heating the first fabric, hermetically sealing the mold containing the layered first fabric, and removing gas from the hermetically sealed mold (e.g., using a vacuum pump).

In some embodiments, the pressing of the first fabric layered in the mold and the heating of the first fabric layered and pressed in the mold comprises rolling the first fabric layered in the mold with a roller or pressing/rolling between two rollers (e.g., one or more heated roller).

In some embodiments, the pressing is carried out in the absence of a mold. Rather, the material is fed between two or more rollers. In some embodiments, one or more of the rollers is heated. In other embodiments, heat is provided by an external heat source. Pressured rolling at comparatively high temperature makes adjacent layers of metal form a single, continuous piece.

In some embodiments, obtaining the first fabric made from the composite thread includes forming a composite thread (e.g., by twisting the first fiber material with the second fiber material), and forming the first fabric from the composite thread (e.g., by weaving, knitting, crocheting, knotting, and or felting).

In some embodiments, the temperature difference between the first melting temperature and the second melting temperature is at least 100° C., for example, where the armoring fibers are nylon and the binding-agent fibers are polyvinylchloride. In other embodiments, the temperature difference between the first melting temperature and the second melting temperature may be as much as 2000° C. degrees, for example, where the armoring fibers are glass fibers with a melting temperature of about 2100° C. and the binding-agent fibers are polyvinylchloride. In other embodiments, the temperature difference between the first melting temperature and the second melting temperature is at least 50° C. degrees, or at least 75° C., 100° C., 200° C., 300° C., 400° C., 500° C., 750° C., 1000° C., 1250° C., 1500° C., 1750° C., or 2000° C.

In some embodiments, the third temperature is at least 50° C. degrees below the second melting temperature, for example where the armoring fibers are nylon and the binding-agent fibers are polyvinylchloride. In other embodiments, the third temperature is at least 75° C., 100° C., 200° C., 300° C., 400° C., 500° C., 750° C., 1000° C., 1250° C., 1500° C., 1750° C., or 2000° C. below the second melting temperature.

In some embodiments, the first fiber material is one or more of an organic polymer fiber, a glass fiber, a metal fiber, or a metal alloy fiber.

In some embodiments, the first fiber material is an organic polymer fiber and the organic polymer fiber is one or more of a nylon fiber, a kapron fiber, a polyethylene fiber, a polypropylene fiber, and a polyvinylchloride fiber.

In some embodiments, the second fiber material is one or more of a carbon fiber, a glass fiber, a mineral fiber, an aramid fiber, a nylon fiber, a metal fiber, or a metal alloy fiber.

In some embodiments, the first fiber material is an aluminum fiber and the second fiber material is a glass fiber or a carbon fiber.

In some embodiments, the first fiber material is one or both of a carbon fiber and a titanium fiber, and the second fiber material is a nylon fiber.

In some embodiments, the first fiber material is a first glass fiber, and the second fiber material is a second glass fiber, wherein the melting temperature of the first glass fiber is at least 100° C. less than the melting temperature of the second glass fiber. In other embodiments, the third temperature is at least 200° C., 300° C., 400° C., 500° C., 750° C., 1000° C., 1250° C., 1500° C., 1750° C., or 2000° C. below the melting temperature of the second glass fiber.

The melting temperature of different types of glass varies from about 70° C. up to about 2500° C. This is why a single composite material can be formed entirely with glass fibers, in accordance with some embodiments. For example, a composite material can be formed with glass binding-agent fibers having a melting temperature of about 250° C., about 450° C., or both (e.g., two different types of glass binding agent fibers) and glass armoring fibers with melting temperatures of about 1200° C., or higher.

In a second aspect, the present disclosure provides a composite article of manufacture prepared according to any of the methods described herein.

In one some embodiments, the article of manufacture is an aircraft skin, the first fiber material is an aluminum fiber and the second fiber material is a glass fiber or a carbon fiber.

In some embodiments, the article of manufacture is a car panel (e.g., a door, hood, roof, trunk cover, etc.), the first fiber material is one or both of a carbon fiber and a titanium fiber, and the second fiber material is a nylon fiber.

In some embodiments, the article of manufacture is a glass article (e.g., a siding, panel for building industry), the first fiber material is a first glass fiber, and the second fiber material is a second glass fiber, wherein the melting temperature of the first glass fiber is at least 100° C. less than the melting temperature of the second glass fiber. In other embodiments, the third temperature is at least 200° C., 300° C., 400° C., 500° C., 750° C., 1000° C., 1250° C., 1500° C., 1750° C., or 2000° C. below the melting temperature of the second glass fiber.

In some embodiments, the article of manufacture is a glass article (e.g., like disposable tableware which can be recycled multiple times), the first fiber material is a first glass fiber, and the second fiber material is the same glass fiber, and where process of thermal integration is carried out at temperature and/or temperature conditions of surficial softening of first fiber material.

### EXAMPLES

The aviation industry is constantly looking for materials with lower weight and higher strength/durability. One of the materials used for aircraft skin is a leaf of aluminum with piece of aramid fabric glued to the back side. This combination of metal and fibrous material is used because the aircraft skin must be able to deform without breaking, as allowed by the metal material and tensile strength from fiber material. Using glass fibers with high melting temperature (or carbon fibers), as armoring fibers, and aluminum fibers, as binding-agent fibers, fabrics can be produced with one or more layers (better multiple layers) of which after process of thermal integration/joining can be converted into a metal-fiber composite, where aluminum fibers are melted and joint together into matrix which “embraces” the glass fibers. Such material can be used, for example, for aircraft skin or for other structural elements. Similarly, this material can be used by the automotive industry. No conventional manufacturing methods allow for the production of such composite materials having any thickness, and particularly not at the high speed, with uniform distribution of metal matrix provided by the methods described herein.

The automobile industry also suffers from the insufficient properties of existing polymer-fiber composites because they crack, due to their high tensile strength. These materials crack into pieces during car crashes, instead of folding and absorbing the crash energy as metal car bodies do. Because of this, a material was developed with a composite carbon and titanium base fixed with a liquid resin. To improve upon this composite material, the methods described herein can be used by substituting the liquid resin for a nylon binding-agent fiber (e.g., with a melting temperature of about 280° C.), which will allow faster manufacturing. This will also provide a material that is less friable, because the carbon and titanium fibers will remain as linear fibers, improving the flexibility of the composite material.

In one example, glass fibers with high melting temperature (e.g., 1,200° C.) are used as armoring fibers and glass fibers with low melting temperatures are used as binding agent fibers, to make a composite thread. This tread, or a textile formed by this tread, is then used to produce composite glass articles, for example, non-friable tableware, water-proof sidings and panels for indoor and outdoor building use (e.g., which are also not prone to mold and fire-resistant), and washbasins for kitchen and bath.

### Concluding Remarks

It will be understood that, although the terms “first,” “second,” etc. may be used herein to describe various elements, these elements should not be limited by these terms. These terms are only used to distinguish one element from another. For example, a first object could be termed a second object, and, similarly, a second object could be termed a first object, without changing the meaning of the description, so long as all occurrences of the “first object” are renamed consistently and all occurrences of the “second object” are renamed consistently. The first object and the second object are both objects, but they are not the same object.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included exemplary systems, methods, and apparatuses that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method for preparing a composite article of manufacture, comprising:
obtaining a first fabric made from a composite thread, the composite thread comprising a first fiber material having a first melting temperature and a second fiber material having a second melting temperature;
layering the first fabric in a mold for the composite article of manufacture;
pressing and/or forming the first fabric layered in the mold; and
heating the first fabric layered and pressed in the mold at a third temperature, wherein the third temperature is at or above the first melting temperature of the first fiber material and below the second temperature of the second fiber material.

2. The method of claim 1, further comprising:
prior to heating the first fabric:
hermetically sealing the mold containing the layered first fabric, and
removing gas from the hermetically sealed mold.

3. The method of claim 1, wherein the pressing of the first layered fabric is between two or more rollers.

4. The method of claim 1, wherein obtaining the first fabric made from the composite thread comprises:
twisting the first fiber material with the second fiber material to form the composite thread; and
forming the first fabric from the composite thread.

5. The method of claim 1, wherein the temperature difference between the first melting temperature and the second melting temperature is at least 100 degrees Celsius.

6. The method of claim 1, wherein the third temperature is at least 100 degrees Celsius below the second melting temperature.

7. The method of claim 1, wherein the first fiber material is one or more of an organic polymer fiber, a glass fiber, a metal fiber, or a metal alloy fiber.

8. The method of claim 7, wherein the first fiber material is an organic polymer fiber and the organic fiber is one or more of a nylon fiber, a kapron fiber, a polyethylene fiber, a polypropylene fiber, and a polyvinylchloride fiber.

9. The method of claim 1, wherein the second fiber material is one or more of a carbon fiber, a glass fiber, a mineral fiber, an aramid fiber, a nylon fiber, a metal fiber, or a metal alloy fiber.

10. The method of claim 1, wherein the first fiber material is an aluminum fiber and the second fiber material is a glass fiber or a carbon fiber.

11. The method of claim 1, wherein the first fiber material is one or both of a carbon fiber and a titanium fiber, and the second fiber material is a nylon fiber.

12. The method of claim 1, wherein, the first fiber material is a first glass fiber, and the second fiber material is a second glass fiber, wherein the melting temperature of the first glass fiber is a least 100 degrees Celsius less than the melting temperature of the second glass fiber.

13. A composite article of manufacture prepared according to the method of claim 1.

14. The composite article of manufacture of claim 13, wherein the article of manufacture is an aircraft skin, the first fiber material is an aluminum fiber and the second fiber material is a glass fiber or a carbon fiber.

15. The composite article of manufacture of claim 13, wherein the article of manufacture is a car panel, the first fiber material is one or both of a carbon fiber and a titanium fiber, and the second fiber material is a nylon fiber.

16. The composite article of manufacture of claim 13, wherein the article of manufacture is a glass article, the first fiber material is a first glass fiber, and the second fiber material is a second glass fiber, wherein the melting temperature of the first glass fiber is a least 100 degrees Celsius less than the melting temperature of the second glass fiber.

17. The composite article of manufacture of claim 13, wherein the article of manufacture is a glass article, the first fiber material is a first glass fiber, and the second fiber material is the first glass fiber, and wherein the composite material is formed at a temperature that softens, but does not completely melt, the first fiber material.
